(19) United States
(12) Patent Application Publication
(10) Pub. No.: US 2025/0304153 A1
(43) Pub. Date: Oct. 2, 2025

(54) METHOD AND CONTROL UNIT FOR OPERATING A STEER-BY-WIRE STEERING SYSTEM, AND STEER-BY-WIRE STEERING SYSTEM

(71) Applicant: ZF Friedrichshafen AG, Friedrichshafen (DE)

(72) Inventor: Oliver Zboron, Lemförde (DE)

(73) Assignee: ZF Friedrichshafen AG, Friedrichshafen (DE)

(21) Appl. No.: 18/863,251

(22) PCT Filed: Apr. 18, 2023
(86) PCT No.: PCT/EP2023/059944

§ 371 Date: Nov. 5, 2024

(30) Foreign Application Priority Data
May 6, 2022 (DE) 10 2022 204 473.8

(51) Int. Cl. B62D 6/00; B62D 5/00

(52) U.S. Cl. CPC B62D 6/00; B62D 5/001

(57) ABSTRACT

A method is disclosed for operating a steer-by-wire steering system for a motor vehicle at speeds from a standstill up to parking and/or maneuvering. The method includes detecting a rotation speed (r_sm_cur) of a spindle nut (25) of the spindle drive (20), detecting a vehicle speed (v_cur), determining a limit value (r_sm_lim) of a rotation speed of the spindle nut (25) at least as a function of the speed (v_cur) of the vehicle, and activating the actuator (10) in order to set a steering angle (RLwᵥ, RLwₕ) of at least one wheel (5, 6), using the limit value (r_sm_lim) of the rotation speed of the spindle nut.

### RELATED APPLICATIONS

This application claims the benefit under 35 U.S.C. § 371 as a U.S. National Phase Application of application no. PCT/EP2023/059944, filed on 18 Apr. 2023, which claims the benefit of German Patent Application no. 10 2022 204 473.8 filed on 6 May 2022, the contents of which are hereby incorporated herein by reference in their entireties.

### FIELD OF THE DISCLOSURE

The invention relates to a method and control unit for operating a steer-by-wire steering system and to a steer-by-wire steering system for a motor vehicle, according to the present disclosure.

### BACKGROUND

From DE 10 2014 206 934 A1 an actuator with a positionally fixed spindle nut and a spindle which is secured against rotation and can be moved relative to the spindle nut are known. At least one end of such an actuator, which is used in a steer-by-wire steering system, is connected to a wheel carrier by means of a steering linkage. By virtue of the linear displacement of the spindle, the wheel steering angle of a wheel mounted to rotate on a wheel carrier can be changed. The steer-by-wire steering system, which for example can be actuated at least indirectly by means of a steering handling device such as a steering wheel or independently thereof, is controlled via the signal path, i.e., without any mechanical coupling. During a steering process, such a steering system has to overcome some frictional resistance of the wheels against the road and within the spindle drive itself. Particularly at very low speeds, such as while maneuvering or parking to a standstill of the motor vehicle, comparatively large steering forces are required, which stress the actuator severely. Owing to alternating static friction and sliding friction between the flanks of the threads on the spindle nut and the spindle, the spindle in the spindle drive of the actuator tend to undergo resonance vibrations and the spindle drive reaches high temperatures, which can result in damage to the actuator and hence to the steer-by-wire steering system.

### SUMMARY

Against this background the purpose of the present invention is to indicate an improved method and a control unit for operating a steer-by-wire steering system, and a steer-by-wire steering system of a motor vehicle, for use when one or more wheels on an axle of the vehicle is/are steered while at rest or when parking or maneuvering at very low speed.

According to a first aspect of the invention a method for operating a steer-by-wire steering system of a motor vehicle is indicated, which vehicle is being driven at a very low speed compared with normal driving, such as from a standstill to parking and/or maneuvering. The method comprises at least the following steps:
a. Detection of a rotation speed of a spindle nut of a spindle drive,
b. Detection of a speed of the vehicle,
c. Determination of a limit value of a rotation speed of the spindle nut at least as a function of the speed of the vehicle,
d. Activating the actuator so as to adjust a steering angle of at least one wheel on a vehicle axle, using the limit value of the rotation speed of the spindle nut.

The steer-by-wire steering system comprises an actuator with a spindle drive for the axial displacement of the spindle. The actuator of the steer-by-wire steering system of the motor vehicle preferably has a housing in which a spindle and a rotatable but positionally fixed spindle nut are mounted. The spindle and the spindle nut form a movement thread and, within the housing, form part of a spindle drive for moving the spindle axially relative to the spindle nut and hence also relative to the housing. For that purpose, the spindle has an external thread which engages with the internal thread of the spindle nut. When the spindle nut is driven in rotation, for example by an electric motor, preferably indirectly via a transmission system, particularly a belt transmission and most particularly a toothed-belt transmission, then the movement thread causes the spindle secured against rotation to move along its longitudinal axis relative to the spindle nut and the housing. By virtue of the axial displacement of the spindle along its longitudinal axis the wheel steering angle of a wheel arranged rotatably on a wheel carrier connected at least indirectly to an end of the spindle can be changed.

The large positioning forces required during steering create severe friction in the transmission of the actuator, especially in the movement thread of a spindle drive of the actuator. Even when optimized lubricants are used, severe friction is created between the thread flanks inside the movement thread, i.e., between the spindle and the spindle nut. Owing to the static friction and the sliding friction taking place at the contact surfaces of the thread surfaces in contact with one another, a so-termed “stick-slip” effect may occur. This is the alternating sticking and sliding of the thread flanks, which can result in fluctuating torques between the spindle nut and the spindle. Then for example, the spindle can be excited into vibrations, in particular rotary vibrations. Continual or temporary excitation over a minimum period of time can reach a resonance frequency of the spindle or other components in the actuator. In addition, the vibrations result in thermal loads which can have an adverse effect on the lubricating properties of the lubricant. This can affect the lifetime of the actuator in a negative manner.

The above-mentioned rotary vibration is also known as torsional vibration. In contrast to translational vibrations, in the case of rotary vibration the vibrations take place about the rotational degree of freedom of a system, here about the longitudinal axis of the spindle. In both cases the vibrations are mechanical.

The term “stick-slip effect” derives from the two English words “stick” and “slip.” In physics and technology, the stick-slip effect describes an as a rule undesired jerky sliding (standstill—sliding—standstill—sliding) of solid bodies moving one against the other.

A steer-by-wire steering system is a steering device decoupled from any mechanical link to a steering handling device or steering wheel. This steering device can even be operated entirely by a control unit, for example in an autonomously driving vehicle. The driver's steering movement by means of a steering handling device is not transmitted to the wheel carriers and wheels by mechanical means such as a linkage. Rather a steering angle, also called a wheel steering angle, and its change for the wheels of an axle are calculated, for example, in a control unit, which then sends control signals to the actuator or actuators of the steer-by-wire steering system and ultimately brings about the steering angle change or adjustment of the steering angle at the wheel concerned. In this, the steering angle demand by the driver or a calculated steering angle change can deviate from the maximum possible steering angle that can be set at the axle concerned, for example it may be larger. In such a case the maximum possible steering angle at most can be set. The steering angle demand consists in changing the steering angle from a current steering angle to an intended steering angle, this steering angle demand also being dependent on time. As an example, let it be said here that a driver can turn a steering wheel slowly, for example at 2°/s, or very rapidly, for example at 20°/s in order to change a wheel steering angle, for example, by 5°. In other words, on the one hand the change of angle, and on the other hand the rate of the angle change, are detected.

When a steering device is being operated normally, then most of the time small wheel steering angle changes are carried out when the vehicle is driving at a speed substantially higher than the range indicated above or when driving in a restricted location, for example at 30 to 50 km/h or, on a roadway or autobahn at even higher speeds. There, as a rule steering angle changes of less than 1° can be assumed. Thus, for these small changes, by comparison much smaller control forces are needed, so rotary vibrations occur hardly or even not at all.

The approach presented here is based on the recognition that in some situations a higher torque or greater force is required to steer, or in other words to move the wheel concerned to a desired steering angle. The situation considered here relates to a very low speed of the vehicle from rest to parking and/or maneuvering. When fully at rest the speed is equal to 0 km/h. When parking and/or maneuvering a speed lower than or equal to 5 km/h is assumed. In a speed range of 0 to about 1 km/h particularly large forces are required in order to set the desired steering angle. The lower the speed, the larger are the steering forces expected that have to be produced via the actuator of the steer-by-wire steering system. This is because the total weight of the vehicle rests on the tires. The contact between tires and road is the tire contact area. The size of the contact area of a tire depends in the first place on the wheel load and the pressure in the tire, because the internal pressure of the tire carries most of the wheel load. However, the width of the tire, its diameter and the rigidity of the sidewalls also play a part. When a wheel is at rest a larger force is needed to steer it, i.e., to rotate it about its vertical axis, than when the wheel is rolling, because the vehicle is moving. As the rolling movement increases, i.e., as the speed of the vehicle increases, a progressively smaller force is required for steering. It is clear that besides the mass of the vehicle, the temperature of the surroundings and the tire temperature have an influence since they directly affect the friction between the tire and the surface of the road. Non-exclusively, the following additional parameters can also be mentioned: tire mix, tire type, friction coefficient of the tire, road surfacing type and road condition (dry, wet, dirty, packed snow, etc.).

The tire of a wheel is as a rule made of rubber-an elastic material. If now a force for steering the wheel is exerted upon the wheel by the actuator of a steer-by-wire steering system, then a prestress is imposed due to the static friction and sliding friction between the tire and the road surface. The tire is, so to speak, raised relative to the road and thereby prestressed. Additional prestress is produced between the actuator and the wheel carrier due to the bearings and, if present, linkages used, for example a steering linkage, according to the design of the chassis.

If now, in the above-mentioned low speed range the steer-by-wire steering system steers back from a large steering angle, preferably starting from a maximum possible steering angle to a smaller steering angle, the prestresses are first reduced for a short time and then prestresses reappear. The prestress increases the lower is the speed of the vehicle, or when the speed is reduced from rolling to a standstill. Accordingly, when parking and/or maneuvering, this prestress is continually changing. When steering back from the previously set large steering angle there is a change of the force direction in the actuator of the steer-by-wire steering system. This results in a change of load within a transmission or spindle drive of the actuator, so that in turn the stick-slip behavior changes. This can lead to vibrations and high thermal loads in the actuator or its movement thread. The aim is to reduce or minimize that behavior.

According to the invention, in the above-mentioned method, as a function of the speed of the vehicle at the time the rotation speed of the spindle nut of the actuator of the steer-by-wire steering system is limited, preferably starting from the nominal rotation speed with which it is usually operated. In the spindle drive of the actuator, by limiting the rotation speed an improved behavior of the friction partners in the actuator, such as the thread flanks of the movement thread that are in contact with one another, can be achieved. In that way, the above-mentioned rotary vibrations and also the thermal loading are minimized or even do not occur in the first place.

The rotation speed is limited by means of the step of determining a limit value of a rotation speed of the spindle nut. The limit value is determined at least as a function of the speed of the vehicle at the time. The rotation speed of the spindle nut is determined continually, preferably at intervals, particularly intervals of 10 ms. For this, an instantaneous vehicle speed is detected continually, preferably at intervals and particularly at intervals of 10 ms, which vehicle speed exists due to the wish of the driver expressed by pressing the accelerator pedal, for example. The rotation speed of the spindle nut is preferably detected by means of a sensor system. The rotation speed can be detected by means of a sensor preferably arranged in the housing. preferably a contactless sensor. For this, for example an incremental sensor can be used. In a preferred embodiment, to determine the rotation speed of the spindle nut a rotor position sensor of the driving electric motor is used. Such a rotor position sensor is preferably designed as an incremental sensor. To put it simply, the rotations of the motor are counted, in particular as a function of time. In the case of indirect driving of the spindle nut by means of a transmission, preferably a belt transmission, particularly by means of a toothed belt transmission, the rotation speed of the spindle nut can be determined from a knowledge of the rotation speed of the electric motor. In particular, the rotation speed is determined by computation in a control unit.

For example, during parking the steering angle set at the front axle can be the largest possible angle so that the wheels are turned as far as possible in a direction, for example to the left. Owing to this steering angle demand, a control unit would set a maximum steering angle of the steer-by-wire steering system in the opposite direction at a rear axle, for example to the right. Typically, after such a steering maneuver during parking the vehicle comes to rest. The actuator of the steer-by-wire steering system also comes to rest and for a moment no steering angle adjustment at all is carried out. Now, the driver again turns the steering wheel back in the opposite direction and/or a change of the driving speed due to a calculated change or a changed accelerator pedal position is carried out. Alternatively, a driving assistance such as a parking assistance system can have brought about the changes. Moreover, these changes take place at a certain rate. These parameters are detected by the control unit and in the limit value determination step the limit value of the rotation speed of the spindle nut is limited as a function of the speed of the vehicle. Finally, having regard at least to these parameters and using the limit value, the actuator of the steer-by-wire steering system is activated in order to set the steering angle. This now happens at a rotation speed of the spindle nut different from and preferably lower than the otherwise used nominal rotation speed. This results in different frictional behavior in the spindle drive or friction partners of the movement thread owing to a relative speed between the flanks of the internal thread of the spindle nut and the external thread of the spindle which deviates from normal operation at the nominal rotation speed. The stick-slip behavior mentioned earlier changes and reduces or prevents torsional vibrations in the spindle drive. The actuator is preferably activated by a control unit such as a control device or a control system. The control unit is preferably part of the steer-by-wire steering system. However, the actuator can also be activated by some other control device built into the vehicle, which is not part of the steer-by-wire steering system.

Without such limiting by using a limit value the drive, for example an electric motor, would be brought to a nominal rotation speed by virtue of a predefined acceleration which has been established for setting a steering angle by the design of the steer-by-wire steering system. Conditional upon the rotation speed of the drive, and if necessary, with the interposition of a gear system, a rotation speed of the spindle nut is obtained. In other words, the nominal rotation speed, in correlation with the gear system or the spindle drive of the actuator, brings about a predefined adjustment speed which ultimately produces a steering rate and is also called the steering gradient. The steering gradient indicates by what angle in unit time, for example by how many degrees per second, the steered wheel concerned can be adjusted about its vertical axis. For different driving situations at different driving speeds and boundary conditions, such as vehicle loading, tire type used, or roadway condition, different steering gradients can be established. At the above-mentioned nominal rotation speed the actuator can work, for example, at an adjustment rate such that in the case of a vehicle which is ready to drive and not loaded, with its wheels on a dry road, the wheels can be moved with a steering gradient for example of up to 18°/s by means of the steer-by-wire steering system. However, owing to the friction between the tires and the road at a low speed, such as when parking and/or maneuvering, the steering rate can be lower with a steering gradient, for example, of 2° to 8°/s. In contrast, at very high speeds as for example 200 km/h, the steering gradient is reduced or limited for example to 0.25°/s so as to avoid sudden steering movements which can cause dangerous driving situations.

In this context “large steering angles” refers to steering angles in the range of the maximum possible steering angle of the axle concerned enabled by its design. During maneuvering and/or parking, the vehicle speed and the wheel steering angles are also changed frequently. By using larger, preferably the largest possible steering angles it is easier to drive into a parking space or to maneuver with a trailer, for example. It is therefore particularly advantageous if in addition to the front axle, the rear axle of the motor vehicle as well can be steered.

A steering angle of 0° is also called the central position or the neutral steering angle and corresponds to driving the vehicle off in a straight line when at each steered axle and each steered wheel a (wheel)-steering angle of 0° is set. The wheels are then parallel to the longitudinal direction of the vehicle.

In a preferred embodiment, the limit value is used at least temporarily. The limit value is cancelled when a vehicle speed is reached above which, for example, limiting of the rotation speed of the spindle nut is no longer needed. It is also possible for the limit value to be used for a predefined time so that after the lapse of the time, the limit value is restored to a nominal or maximum value, or cancelled. As a function of an intended vehicle speed, a previously determined limit value can also be changed, in particular reduced starting from the previously set value, in order to take account of an imminent changed driving situation. The reason for that can be a changed position of the accelerator pedal or a calculated or necessary speed change owing to a changing road surface (ice, road with varying friction values, for example on each side of the vehicle).

In a further preferred embodiment, in the limit value determination step the limit value is set to a predefined minimum value. For example, such a predefined minimum value can correspond to half or three-quarters of the nominal rotation speed of the spindle nut at which a displacement of the spindle determined by design is possible within a predefined time. Advantageously, this also ensures that the rotation speed is always sufficient for an intended steering movement and can be adapted for any conceivable condition or driving situation. In other words, it is ensured that having regard to the driving situation of the vehicle, a trouble-free wheel steering angle change can be carried out without any damaging temperature increase or resonance vibrations in the actuator. The nominal rotation speed of the spindle nut is a value determined by design which is decisive for the movement speed of the actuator of the steer-by-wire steering system. Later it will be described how the nominal rotation speed can be exceeded at least temporarily in order to compensate a so-termed offset. Thus, the movement speed of the actuator can also be maintained even when the limit value for the rotation speed of the spindle nut is in temporary use, so that the movement speed of the actuator is not influenced or not appreciably so. The nominal rotation speed can be exceeded up to a maximum value for the rotation speed of the spindle nut, this value for example being a design value limited by the transmission and/or the electric motor.

In the step of determining a limit value, the rotation speed limitation is carried out at least as a function of the instantaneous vehicle speed. Advantageously, besides an instantaneous steering angle demand the position of the spindle and/or the driving situation is/are also taken into account. As regards the steering angle demand it has already been mentioned above that this can turn out in different ways. For example, during parking a very large change of the steering angle maybe carried out, moving from as far as possible to the left to as far as possible to the right. This, for example, can be controlled in accordance with the driver's wish, with a fast rate of change by means of the steering handling device. In such a case the position of the spindle inside the housing of the actuator changes to the maximum extent. Furthermore, it can also be that very wide tires are used on the vehicle and the vehicle is heavily loaded. The environmental temperature (temperature of the lubricant in the spindle drive, temperature of the road and temperature of the tires) also plays a significant part, since at low temperatures the friction values are higher, for example due to changing viscosity of the lubricant. By additionally taking into account the steering angle demand and/or the spindle position and/or the driving situation, the determination of the limit value for the rotation speed of the spindle nut can be optimized still further.

In a further preferred embodiment, vibrations of the actuator, preferably anticipated resonance vibrations are detected, and these are taken into account in the limit value determination step. This can be done by means of suitable sensors such as structure-borne sound sensors, preferably by means of micro-mechanical piezoelectric signal sensors. For example, at least one signal sensor is attached fast to the housing of the actuator, preferably arranged inside the housing. The connection to the control unit can be wireless or by way of a signal line. If the vibration reaches a level stored in the control unit, then it is taken into account in the determination of the limit value of the rotation speed of the spindle nut.

Furthermore, steering angle ranges can be determined such that a particular range can be assigned to a particular limit value. In the case of a steering angle smaller than 50 to 80% of a maximum possible steering angle, a limit value can be determined in the determination step which is different from that outside that range. Preferably the range can be restricted to a steering angle smaller than 65 to 70% of a maximum possible steering angle. For example, there is a first range with a steering angle of 0 to 70% of a maximum possible steering angle and a second range with a steering angle larger than 70% up to the maximum possible steering angle. For example, a rear axle can be designed to have a maximum possible steering angle of 10°. If that maximum steering angle is set and steering-back takes place, for example to 8°, then the rotation speed of the spindle nut is limited in accordance with the second range. In the first range, namely 0 to 70% or in this case therefore between 0 and 7°, for example no limitation is imposed because with steering angles of that order of magnitude the prestress is so small that rotary vibrations in the actuator are negligible or do not take place. In other words, a limit value can preferably be determined above 70% up to 100% of the maximum steering angle. Preferably the limit value is cancelled when the steering angle is changed within the range 0 to 70% or reaches that range. Advantageously, the assignment of the ranges can be stored in the form of a characteristic curve in a control unit, so that during the determination step a respective limit value can be called up or assigned after referring to the characteristic curve.

For different driving situations, different characteristic curves can be stored in a control unit. This consideration takes into account that a predefined maximum steering angle that is possible by virtue of design with the steer-by-wire steering system in the vehicle concerned can change owing to boundary conditions. For example, such a driving situation can arise due to the loading of the vehicle. For example, due to the loading the wheels are covered more deeply by the wheel arches and the maximum steering angle has to be limited because otherwise the wheels or tires would encounter the chassis or the vehicle body if the designed maximum possible steering angle were to be set. The loading also results in a higher wheel load, which then demands a larger force for steering. In a known manner the loading of the vehicle can be detected by means of suitable sensors such as a height-level sensor. By virtue of the height-level sensor it is possible for example to choose a characteristic which can include a smaller maximum steering angle. A limited maximum steering angle can for example also be required if wider tires or snow-chains etc. are used. Owing to the available structural space in the area of the wheel arches, it may also be necessary for the maximum available steering angle to be limited for example by a characteristic because not enough room is available for steering movements. For that purpose, the wheels or tires can for example be fitted with RFID sensors that signal to a control unit the condition of the tires. Thus, by virtue of that possibility support points for limit values to restrict the acceleration, which differ from the normal condition of the vehicle and suffice for the driving situation of the moment, can be obtained.

Preferably, the loading and the resulting higher wheel loads are taken into account in at least one characteristic curve.

If the vehicle is moving at the above-mentioned low speed, the limited value, i.e., the limited rotation speed of the spindle nut results in a slower change of the steering angle. To reach a desired steering angle specified by a steering angle demand, the actuator is basically moved at a predefined adjustment rate in order to be able to set a steering angle at the wheels of an axle in accordance with the steering angle demand within a given time. Due to the rotation speed limitation, there will be an offset such that the required steering angle is reached later than if there had been no limitation. To compensate that offset, the steering rate or steering gradient is changed at least temporarily, preferably increased. For that purpose, the predefined adjustment rate is increased, taking into account the steering angle required and/or a steering angle set at the time and/or the speed of the vehicle at the time. In other words, after the slower rotation of the spindle nut by virtue of the limit value its rotation speed is increased at least temporarily to a higher rotation speed and thus accelerated to a higher steering gradient. Advantageously, in that way, and despite the limited rotation speed, the steering angle change by the steer-by-wire steering system takes place in the same time as with the nominal rotation speed with no limitation. At a vehicle speed from rest up to a maximum of 1 km/h, preferably up to 0.7 km/h, the steering gradient can be is a range from 0 to 12°/s. Depending on the steering angle demand the steer-by-wire steering system is operated at a rate required by the adapted steering gradient. For a temporary increase of the steering gradient, it can be increased by 20 to 70%, preferably 30 to 50%. Preferably, the maximum steering gradient can be increased from 12°/s in this case, by 4 to 6°/s up to 18°/s, so that the intended steering angle change can take place in the specified time, i.e., as far as possible in accordance with the steering angle demand. The increase is preferably controlled in such manner that the range that is critical for the excitation of vibrations is excluded if possible.

When the vehicle stops driving slowly and increases its speed, particularly if the speed of the vehicle increases substantially for example due to a sudden high acceleration of the vehicle, in order to avoid an abrupt rotation speed change and thus a sudden steering movement it can be provided that with increasing speed no hard change of the rotation speed and thus of the steering gradient takes place. The limit value for limiting the rotation speed is preferably not changed abruptly. Instead, the adaptation is gradual in the sense of a smooth transition of the previously changed rotation speed to a target value, or to the nominal value. This is advantageous from the standpoints of driving safety, control of the vehicle and driving comfort.

In another preferred embodiment, in a further step the instantaneous speed of the motor vehicle is determined, particularly at intervals, preferably intervals of 10 ms. In that case, in the limit value determination step the instantaneous speed is taken into account in such manner that above a certain speed limit the limit value is cancelled. The speed limit characterizes the departure from the above-mentioned low speed and is thus higher than 1 km/h, preferably 1.1 km/h, particularly above 0.7 km/h and preferably 0.71 km/h. Preferably, in the method according to the invention the limit value for the limited rotation speed is determined as a function of the instantaneous steering angle of the wheels on the motor vehicle axle concerned. If the steering angle is within the aforesaid range of 0 to 70% of a maximum possible steering angle at the axle concerned, then in this embodiment the rotation speed is preferably not limited in the limit value determination step. In the sense of additional redundancy and to be able to carry out the method with a view to determining the limit value more accurately and more safely for the occupants of the vehicle, the operation of the steer-by-wire steering system can advantageously be improved still further.

From the above-mentioned example embodiment various vehicle parameters are known, some of which can be detected by sensor means. As described earlier, for various vehicle situations there are ranges. As a function, for example, of the speed of the vehicle characteristic curves can be stored in a control unit, which picture particular vehicle parameters in particular ranges. When determining the limit value for the rotation speed of the spindle nut, in the determination step characteristic curves can advantageously be referred to. Such characteristic curves simplify the determination of the limit value and ultimately the setting of the steering angle of at least one wheel on a vehicle axle using the limit value of the rotation speed of the spindle nut.

A particularly advantageous embodiment is one in which, in the step of activating the actuator the steering angle at a steered rear axle of the motor vehicle is controlled. If at the rear axle a steering angle can be set which is in the opposite direction to the steering angle at the front axle, then at low speeds a tighter turning circle is obtained than with a vehicle not having a steered rear axle. Thanks to the steering of the rear axle the vehicle can be maneuvered or parked more easily. The steerable rear axle is preferably steered by a steer-by-wire steering system.

According to a further aspect the invention relates to a control unit for controlling an actuator of a steer-by-wire steering system of a motor vehicle, such that the control unit has the following features:
an interface for the at least indirect detection of a rotation speed of a spindle nut (25), which represents an instantaneous rotation speed (r_sm_cur),
an interface for detecting a vehicle speed which represents an instantaneous speed (v_cur) of the motor vehicle,
an interface for detecting a steering angle which represents an instantaneous steering angle (RLwᵥ_ mom, RLwₕ_mom) of at least one wheel (5, 6) of a motor vehicle,
an interface for detecting a steering angle demand (Lw_req_cur) which represents an instantaneous steering angle change due to a driver's wish, or a change determined by the control unit (SG) or another control unit,
a unit for determining a limit value of the rotation speed of the spindle nut (25) of the actuator (10) of a steer-by-wire steering system (12), which represents a limit value (r_sm_lim), and
a unit for activating the actuator of the steer-by-wire steering system in order to set a steering angle (RLwᵥ, RLwₕ) of at least one wheel 5, 6) using the limit value (r_sm_lim).

The control unit is also able to limit the limited rotation speed temporarily, i.e., for a certain period of time. The control unit can preferably determine, i.e., preferably calculate the instantaneous rotation speed of the spindle nut from the rotation speed of the electric motor. The rotation speed of the electric motor is preferably obtained by means of a rotor position sensor built into it, preferably in the form of an incremental sensor. If necessary, the control unit takes into account any existing gear ratio given by the transmission ratio. The control unit can also determine the position of the spindle, preferably by way of the rotor position sensor of the electric motor. In addition, a linear path sensor can be used to assess the plausibility of the position of the spindle, which sensor preferably operates in a contactless manner.

The control unit can be a control device, which for example can be an electrical device, which processes electrical signals such as sensor signals and as a function thereof emits control signals. The device can have one or more suitable interfaces in hardware and/or software form. In the case of a hardware structure the interfaces can for example be part of an integrated circuit in which functions of the device are implemented. The interfaces can also be stand-alone integrated circuits or can at least consist of discrete structural elements. In the case of a software structure the interfaces can be software modules in the form of or part of a computer program which are implemented, for example, in a microcontroller in addition to other software modules.

Also advantageous is a computer program product with program codes that can be stored on a machine-readable data carrier such as a semiconductor memory, a hard disk memory or an optical memory, the codes being used for carrying out the method in accordance with one of the previously described embodiments when the program is run on a computer or a control unit.

Advantageously, thanks to the invention, without modifying the mechanics of an existing actuator of a steer-by-wire steering system, it is possible by means of control procedures according to the method described to minimize the vibration behavior of the actuator or the components contained therein. In combination with the improvement of the lubricant supply, the lifetime of the steer-by-wire steering system as a whole can therefore be inexpensively improved.

### BRIEF DESCRIPTION OF THE DRAWINGS

Below, the invention is described with reference to preferred embodiments and taking into account the drawing, which shows:

FIG. 1: A vehicle axle with a steer-by-wire steering system,

FIG. 2: An actuator of a steer-by-wire steering system,

FIG. 3: A flow chart of the method according to the invention.

### DETAILED DESCRIPTION

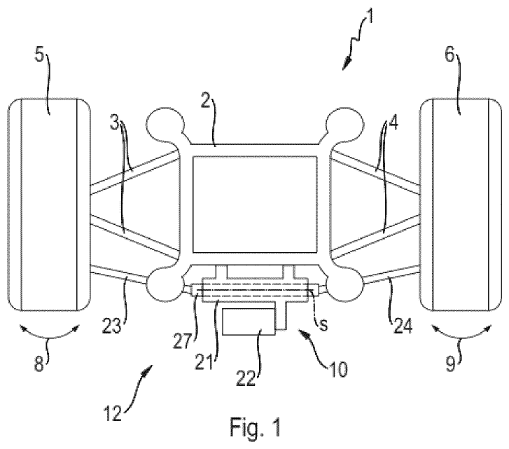

FIG. 1 shows a steer-by-wire steering system 12 known from the prior art on a vehicle axle 1, here viewed from above as a rear axle with a subframe 2, which is attached to or associated with a vehicle body and is connected to the chassis (frame) of the body of a motor vehicle. However, the invention is not limited to a rear axle. The wheels 5 and 6 are linked to the subframe 2 by means of control arms 3, 4. The control arms 3, 4 are part of the wheel suspension of the wheels 5, 6 on the subframe 2. An actuator 10 of a steer-by-wire steering system 12 is arranged on the subframe 2. The actuator 10 with its housing 21 is attached to the subframe 2. In this embodiment the steer-by-wire steering system 12 is in the form of a central linkage that acts upon both wheels 5, 6 of the axle. It comprises a through-going steering tie-rod in the form of a spindle 27 which passes through the housing 21 of the actuator 10 and is designed as an axially displaceable spindle. The electric motor 22 is arranged axis-parallel to the spindle 27. At the ends of the longitudinally displaceable spindle 27 track-rods 23, 24 are pivoted, which are articulated at their ends remote from the actuator 10 in each case to wheel carriers (not shown) of the wheels 5 and 6. It can be seen clearly that by virtue of an axial movement, i.e., a movement of the spindle 27 along its longitudinal axis s in one or the other direction, a change of the wheel steering angle 8, 9 will take place. This results from the fact that the track-rode 23, 24 constitute a forced connection between the respective wheels concerned or their wheel carriers and the actuator 10 itself. To steer the wheels 5, 6, they and the wheel carriers are connected thereto so that they can rotate about their vertical axes.

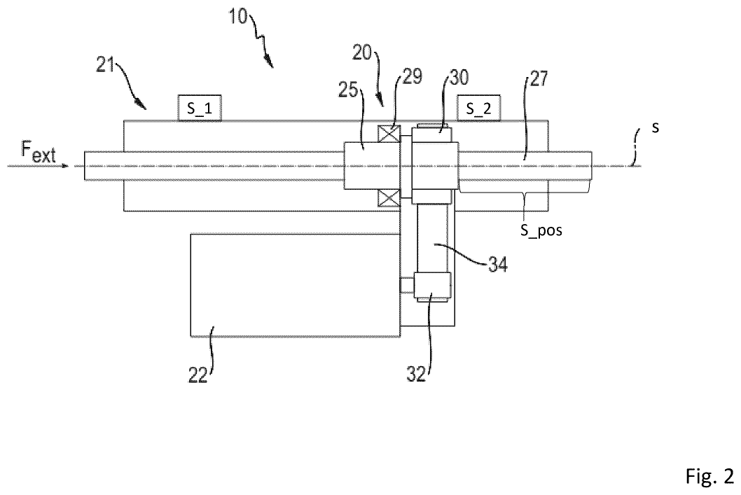

FIG. 2 shows a detailed schematic representation of the actuator 10 already shown in FIG. 1. The actuator 10 has a housing 21 on which an axis-parallel electric motor 22 is arranged. In the housing 21 is arranged the spindle drive 20 which consists of the spindle nut 25 and the spindle 27 with its external thread. The spindle 27 is secured against rotation (not shown). The spindle nut 25 and the spindle 27 are engaged with one another and form a movement thread. The spindle nut 25 is fitted positionally fixed relative to the housing 21 and can rotate by virtue of a roller bearing 29. Passing through the spindle nut 25 and arranged coaxially with it is the spindle (tie-rod) 27 itself. On the side of the spindle nut 25 facing away from the roller bearing 29 a belt wheel 30 is arranged on the spindle nut 25. The electric motor 22 comprises a drive pinion 32. A drive belt 34 in the form of a toothed belt is wrapped round both the drive pinion 32 and the belt wheel 30, so that when the electric motor 22 rotates the spindle nut 25 is driven in rotation without slip about the longitudinal axis s. The drive pinion 32, the belt wheel 30 and the drive belt 34 form a transmission. Depending on the rotation direction of the spindle nut 25 the spindle 27 is displaced or moved linearly in one direction or the other along its longitudinal axis s depending on the rotation direction of the electric motor 22. By virtue of the rotation of the electric motor, the rotation speed of the electric motor 22 in combination with the transmission ratio of the belt drive determines a rotation speed of the spindle nut 25. Due to the action of an essentially axial force Fₑₓₜ upon the spindle 27, for example due to lateral forces of the wheels, the friction in the movement thread can increase. That is because owing to the force Fₑₓₜ the surface pressure of the flanks of the external thread of the spindle 27 against the internal thread of the spindle nut 25 increases. Due to that friction the spindle can be excited into vibrations. As a result, the running smoothness of the spindle drive 20 deteriorates because of a reaction of the friction partners, the spindle nut 25 and the spindle or steering tie-rod 27.

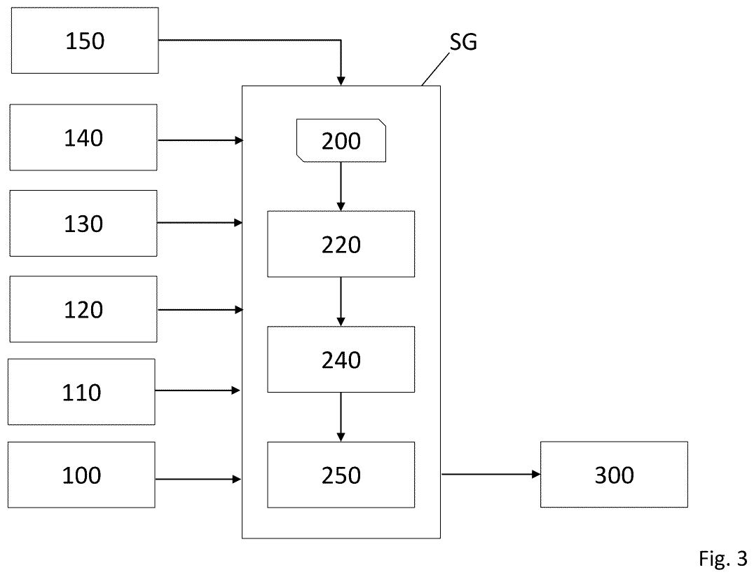

FIG. 3 shows a flow chart with a schematic representation of a method according to the invention. For example by way of a signal bus in the vehicle, such as a CAN bus or a Flexray bus, an instantaneous vehicle speed v_cur, an instantaneous steering angle demand LW_req_cur, a spindle position S_pos, a vehicle situation c_sit, a vibration value vib_cur of the actuator 10 and a rotation speed r_sm_cur of the spindle nut 25 are sent to the control unit SG. For that purpose, respective interfaces 100, 110, 120, 130 140, 150 are provided. In a simple manner the arrows indicate the signal flow of the aforesaid parameters to the control unit SG. In a first step 200 at least the rotation speed r_sm_cur of the spindle nut 25 of the spindle drive 20 and the instantaneous speed of the vehicle v_cur are registered in the control unit SG. The registering of the parameters in the control unit takes place continually and at intervals of 10 ms. In a following step 220 a comparison takes place with the characteristic curves stored in the control unit. By means of the characteristic curves the relationships of the parameters to one another in particular ranges are stored. For example, in a speed range of 0) to 1 km/h the change of a coefficient of friction as a function of a tire size or tire width can be stored. In a further characteristic curve, the change of spindle position S_pos as a function of the rotation speed of the spindle nut 25 can be stored. In another characteristic curve a change of the coefficient of friction within the movement thread as a function of the position S_pos of the spindle relative to the spindle nut 25 can be stored. In a further characteristic curve, the influence of the friction within the spindle drive 20 or within the movement thread upon the vibration behavior of the spindle (steering tie-rod) 27 can be stored. In another step 240 the limit value r_sm_lim of the rotation speed of the spindle nut 25 is determined at least as a function of the speed of the vehicle v_cur. Then the control unit SG can access the characteristic curves stored therein and take into account the value pairings stored in it in accordance with the examples mentioned above.

When the limit value r_sm_lim has been determined, in a further step 250 the actuator 10 is activated so as to set a steering angle RLwᵥ, RLwₕ of at least one wheel 5, 6 on a vehicle axle, for which the limit value r_sm_lim of the rotation speed of the spindle nut 25 is used. Then, in step 300 the actuator 10 adjusts the steering angle with a rotation speed which differs from the nominal rotation speed, namely a lower one owing to the previously determined limit value r_sm_lim. Thanks to the lower rotation speed of the spindle nut 25 compared with the nominal rotation speed, in the current situation resonance vibrations of the spindle 27 are avoided. The limit value r_sm_lim is maintained at least until the speed v_cur of the vehicle increases to above a threshold value, for example higher than or equal to 1 km/h. If for example the characteristic curve stored in the control unit shows that from this speed upward the rotation speed restricted by the limit value r_sm_lim can be increased again to the nominal rotation speed, then the control unit activates the actuator 10 in such manner that the rotation speed of the spindle nut 25 gradually increases from the limited rotation speed r_sm_lim to the nominal rotation speed. Depending on the time for which the rotation speed was limited, the rotation speed of the spindle nut 25 is increased temporarily to a rotation speed that exceeds the nominal rotation speed. This can compensate for the fact that the required change of the steering angle takes place over the same time as if the limit value r_sm_lim had not been used and the spindle nut had been operated at the nominal rotation speed.

The aforesaid consideration of vehicle parameters when determining the limit value of a rotation speed of the spindle nut 25 represents only one possibility, in the sense of an example embodiment. The further parameters also mentioned in that context can be taken into account individually or in any desired combination for determining the limit value of the rotation speed of the spindle nut 25.

The steps of the method according to the invention can be repeated and can be carried out in a sequence other than that indicated. Thus, the invention is not restricted to the sequence mentioned herein.

### INDEXES

1 Vehicle axle
2 Subframe
3 Control arm
4 Control arm
5 Wheel
6 Wheel
8 Wheel steering angle
9 Wheel steering angle
10 Actuator
12 Steer-by-wire steering system
20 Spindle drive
21 Housing
22 Electric motor
23 Track-rod
24 Track-rod
25 Spindle nut
27 Steering tie-rod, spindle
29 Roller bearing
30 Belt wheel
32 Drive pinion
34 Traction means
100 Interface
110 Interface
120 Interface
130 Interface
140 Interface
150 Interface
200 Detection step
220 Step of comparing with characteristic curve
240 Step of determining a limit value (rotation speed of the spindle nut)
250 Step of activating the actuator
300 Steering angle adjustment
c_sit Vehicle situation
Fₑₓₜ Force
Lw_req_cur Steering angle demand
r_sm_cur Rotation speed of the spindle nut
r_sm_lim Rotation speed limit value
RLwᵥ Front (wheel) steering angle
RLwₕ Rear (wheel) steering angle
RLwᵥ_mom Front (wheel) steering angle
RLwₕ_mom Rear (wheel) steering angle
S Longitudinal axis
s_1 Sensor
s_2 Sensor
SG Control unit
S_pos Spindle position
v_cur Speed
vib_cur Vibration value

1. A method for operating a steer-by-wire steering system (12) of a motor vehicle at speeds from a standstill up to parking and/or maneuvering, wherein the steer-by-wire steering system comprises an actuator (10) with a spindle drive (20) for the axial displacement of a spindle (27), the method comprising:
detecting a rotation speed (r_sm_cur) of a spindle nut (25) of the spindle drive (20);
detecting a vehicle speed (v_cur);
determination of determining a limit value (r_sm_lim) of a rotation speed of the spindle nut (25) at least as a function of the speed (v_cur) of the vehicle; and
activating the actuator (10) in order to set a steering angle (RLwᵥ, RLwₕ) of at least one wheel (5, 6) on a vehicle axle, using the limit value (r_sm_lim).

2. The method according to claim 1, wherein determining the limit value (r_sm_lim) includes at least temporarily changing the limit value.

3. The method according to claim 1, wherein determining the limit value (r_sm_lim) is performed while the limit value is set to a predefined minimum value or maximum value.

4. The method according to claim 1, further comprising:
determining at least a steering angle demand (Lw_req_cur) and/or a spindle position (S_pos) and/or a situation of the vehicle (c_sit); and
taking into account the steering angle demand, and/or the spindle position, and or the situation of the vehicle in the determination step of the limit value (r_sm_lim).

5. The method according to claim 1, comprising:
detecting, by means of at least one sensor (s_1, s_2), vibrations of the actuator (10); and
taking into account the vibrations in determining the limit value (r_sm_lim).

6. The method according to claim 1, wherein determining the limit value (r_sm_lim) includes temporarily changing a steering gradient as a function of the instantaneous steering angle demand (Lw_req_cur) and/or of a steering angle (RLwᵥ, RLwₕ) set at the time and/or of the speed (v_cur) of the vehicle at the time.

7. The method according to claim 1, comprising:
determining, at intervals, at least the rotation speed (r_sm_cur) and/or the instantaneous speed (v_cur) of the vehicle;
taking into account the speed (v_cur) of the vehicle; and
cancelling the limit value (r_sm_lim) of the rotation speed of the spindle nut (25).

8. The method according to claim 7, comprising, after the limit value (r_sm_lim) has been cancelled, restoring a nominal value of the rotation speed of the spindle nut (25), as a function of the currently set steering angle (RLwᵥ_mom, RLwₕ_mom) and/or of a steering angle demand (Lw_req_cur) and/or of an intended change of the speed of the vehicle.

9. The method according to claim 1, wherein determining the limit value (r_sm_lim) includes determining vehicle parameters based on at least one stored characteristic curve and using the vehicle parameters.

10. A control unit (SG) for operating a steer-by-wire steering system (12) of a motor vehicle in accordance with the method according to claim 1, the control unit (SG) comprising:
an interface configured for the at least indirect determination of a rotation speed of a spindle nut (25), which represents an instantaneous rotation speed (r_sm_cur);
an interface configured for determining a vehicle speed, which represents an instantaneous speed (v_cur) of the motor vehicle;
an interface configured for detecting a steering angle, which represents an instantaneous steering angle (RLwᵥ_ mom, RLwₕ_mom) of at least one wheel (5, 6) of a motor vehicle;
an interface configured for detecting a steering angle demand (Lw_req_cur) which represents an instantaneous steering angle change in accordance with a driver's wish or a change of a steering angle determined by the control unit (SG);
a unit configured for determining a limit value of the rotation speed of the spindle nut (25) of the actuator (10) of a steer-by-wire steering system (12), which represents a limit value (r_sm_lim); and
a unit configured for activating the actuator (10) of the steer-by-wire steering system in order to set a steering angle (RLwᵥ, RLwₕ) of at least one wheel (5, 6), using the limit value (r_sm_lim).

11. A steer-by-wire steering system operated in accordance with the method according to claim 1, the steer-by-wire steering system (12) being in the form of a rear axle steering system.

12. A machine-readable storage medium with executable code configured, when executed, to carry out the method according to claim 1.

13. (canceled)

14. The machine-readable storage medium according to claim 12 configured to be executed in a vehicle control unit (SG).
